(19) United States
(12) Patent Application Publication
(10) Pub. No.: US 2007/0116293 A1
(43) Pub. Date: May 24, 2007

(54) Method for establishing a communication key between subscribers of a wirelessly operating communication system

(76) Inventors: Jens-Uwe Busser, Munchen (DE); Steffen Fries, Baldham (DE)

Correspondence Address: BRINKS HOFER GILSON & LIONE, P.O. BOX 10395, CHICAGO, IL, 60610, US

(21) Appl. No.: 11/594,639

(22) Filed: Nov. 8, 2006

(30) Foreign Application Priority Data
Nov. 16, 2005 (DE) DE102005054685.4

(51) Int. Cl. H04K 1/00

(52) U.S. Cl. 380/273; 380/247; 380/270

(57) ABSTRACT

A method for agreeing a communication key between communication subscribers of a wirelessly operating communication system is provided. The method for agreeing a communication key includes using a communication key to determine at least one further communication key for security-related services, and exchanging acoustic signals for agreeing the communication key being exchanged between the communication subscribers provided at a subsequent data transmission.

This application claims the benefit of DE 10 2005 054 685.4 filed Nov. 16, 2005, which is hereby incorporated by reference.

### BACKGROUND

1. Field

The present embodiments relate to a method for establishing a communication key between subscribers of a wirelessly operating communication system as well as a corresponding communication subscriber.

2. Related Art

Recently, wireless operating communication systems have become more and more widespread. The communication systems use radio waves for communication between devices over comparatively short distances. The communication systems can utilize, for example, Bluetooth communication systems and WLAN (Wireless Local Area Network) communication systems.

To establish a communication link, a respective communication subscriber must first register at the communication system. The purpose of the registration process is to establish an authorized link. The registration process comprises an initialization phase and a subsequent so-called link key generation, in which a key is generated for the subsequent data communication of the wireless link. For example, such a registration process is referred to in the Bluetooth standard as pairing. The registration process (method), for example, requires a clear registration to be ensured by physical proximity in order to prevent unauthorized subscribers from also taking part in the data communication.

An increasingly important requirement for wirelessly operating communication systems is the security of the registration method. For example, the wirelessly operating communication systems should prevent unauthorized communication subscribers from being able to register to the communication network intentionally or unintentionally. The registration method checks whether an authorized subscriber is involved. An initialization key is generated in the initialization phase. The initialization key essentially forms a shared secret between the two communication subscribers. Different methods exist to generate this initialization key, which are not intended to be detailed further. The link key is then generated from the initialization key and is exchanged between the communication subscribers and monitored. The quality of the link key depends on the security requirements imposed on the communication system.

A password is exchanged between the communication subscribers of the wirelessly operating communication system over a transmission path as a function of the security strategy. The password with, for example, a large bit width is provided as part of the security strategy. The password is exchanged using radio waves. The password may be intercepted by an unauthorized communication subscriber during a registration and subsequently used for unauthorized registration. The unauthorized subscriber could gain access to the communication system.

In another risk in exchanging a password or agreeing to a shared key over a radio link, an attacker may intentionally overlay the actual radio signal of the authorized communication subscriber, which exchanges a password, with a radio signal and deliberately interfere with the communication between the two authorized communication subscribers. For example, the attacker may use a high transmitting power, which is not perceived by the two authorized communication subscribers to interfere with the authorized communication.

In yet another example, a “man-in-the-middle” attack is also possible. The man-in-the-middle attack is used by an attacker that poses as the second communication subscriber to the first communication subscriber, and poses as the first communication subscriber to the second communication subscriber. In this case, the two communication subscribers are not aware of the attacker, since the actual radio signals are interfered with by the attacker and cannot reach the relevant communication subscriber.

Conventional methods for preventing these risks essentially attempt to increase security during the transmission of security-critical parameters by keeping the distance as small as possible during the transmission. For example, two communications devices are placed as close as possible to increase the security during transmission. An element of risk still remains as eavesdropping and the introduction of interference signals are both still possible.

### SUMMARY

In one embodiment, a method for agreeing to a communication key between communication subscribers of a wirelessly operating communication system is provided. The communication key is used to determine at least one further communication key for security-related services. Acoustic signals for agreeing to the communication key are exchanged between the communication subscribers for providing subsequent data transmission.

In one embodiment, the agreed key is used to decrypt security-critical data for a transmission.

In one embodiment, a communication subscriber for a communication system has a communication module for a data transmission. The communication module is operative to transmit and receive data signals. The communication subscriber has a program-control device, which at least controls the data transmission and evaluates the received data signals. The communication subscriber includes an acoustic module for agreeing to a key. The acoustic module is designed to transmit and receive acoustic signals.

In one embodiment, the wirelessly operating communication system is a communication system operating according to the Bluetooth standard. In this embodiment, the communication subscriber is embodied as a Bluetooth subscriber for a communication system operating according to the Bluetooth standard, and the communication module is embodied as a Bluetooth module for a data communication according to the Bluetooth standard. In an alternative embodiment, the wirelessly operating communication system is a communication system operating as a WLAN communication system. In this embodiment, the communication subscriber is embodied as a WLAN subscriber for a communication system operating according to the WLAN standard and the communication module is embodied as a WLAN module for a data communication according to the WLAN Standard. The communication system is not limited to Bluetooth or WLAN communication systems, for example, other suitable wireless communication systems are used.

In one embodiment, the registration method with a communication method and system, also referred to as pairing, is separated from the actual data communication. In one embodiment, the wireless communication between the communication subscribers which is required for agreeing to a communication key between the communication subscribers is carried out with acoustic signals. The acoustic signals are generated exclusively for the agreement of the communication key and, for example, the subsequent direct or indirect identification of an authorized subscriber. An authorized subscriber is understood to be a subscriber which is provided for data communication within the communication system.

The present embodiments can be applied to already existing interfaces on mobile communication devices, for example, interfaces for DTMF (Dual Tone Multi Frequency) communication or interfaces for a modem communication such as V.90. The danger of eavesdropping by a potential attacker is considerably reduced because eavesdropping is only possible with costly receiving devices and corresponding signal amplifiers. The danger of introducing interference signals is also considerably reduced with the present embodiment because the attacker would be noticed by the authorized communication subscribers, for example, when transmission is in the voice band. A directed transmission of acoustic signals is not possible because of the large wavelengths involved.

In one embodiment, the acoustic signals lie in the audible frequency range, for example, in a frequency band of 0.4 KHz to 3.4 KHz.

In one embodiment, a method comprises at least two operational modes, for example, a first operational mode for agreeing to a key between the communication subscribers taking part in a data transmission by exchanging acoustic signals; and a second operational mode, in which the data transmission is carried out following an implemented and successful key agreement.

In one embodiment, the agreement of a key comprises an initialization and a subsequent link key generation. Following the agreement of a key and within the scope of an authentication operation, an authentication is carried out using exchanged acoustic signals. The acoustic signals are exchanged with the initial bootstrapping or to establish a communications link.

In one embodiment, the evaluation (i.e. the authentication of the communication subscriber), is carried out according to the Bluetooth standard. For example, only the pure transmission of acoustic signals is carried out in the acoustic module. The evaluation and authentication are not carried out in the acoustic module. The evaluation or the authentication is carried out, for example, in the communication or Bluetooth module provided for the data communication. The acoustic module or the acoustic signal transmission is thus only used for the registration (i.e. for the transmission of the key and/or Bluetooth Pass Keys). The transmitted cryptological data is not evaluated in the acoustic module. For example, a provision for a corresponding cryptological evaluation unit is not created. Alternatively, the evaluation or the authentication takes place in the acoustic module.

In one embodiment, an initialization key is exchanged between the communication subscribers taking part in the communication. The initialization key is used for further communication between the communication subscribers. For example, a password and/or a PIN number can be transmitted as an initialization key. In one embodiment, a key agreement protocol is used to generate an initialization key. One suitable key agreement protocol is the Diffie-Hellmann protocol; however, any suitable key agreement protocol may be used. In an alternate embodiment, the initialization key is generated by a random number generator.

In one embodiment, the communication subscribers taking part in a registration each have a shared secret, which is exchanged between them in registration mode. In another embodiment, the program-controlled device also controls the method for agreeing to a key and/or evaluates the received acoustic signals. In this embodiment, an evaluation device, which is uniquely used to control the method for agreeing to a key and/or evaluates the received acoustic signals within an acoustic module, is no longer needed.

In one embodiment, the program-controlled device forms part of the communication module or the Bluetooth module. A microprocessor, microcontroller or a hard-wired logic circuit, for example, an FPGA or a PLD, are suitable program-controlled devices.

### BRIEF DESCRIPTION OF THE DRAWINGS

FIG. 1 is a block diagram that illustrates one embodiment of a Bluetooth-based communication system with two communication subscribers;

FIG. 2 is a block diagram that illustrates one embodiment of a communication subscriber.

### DETAILED DESCRIPTION

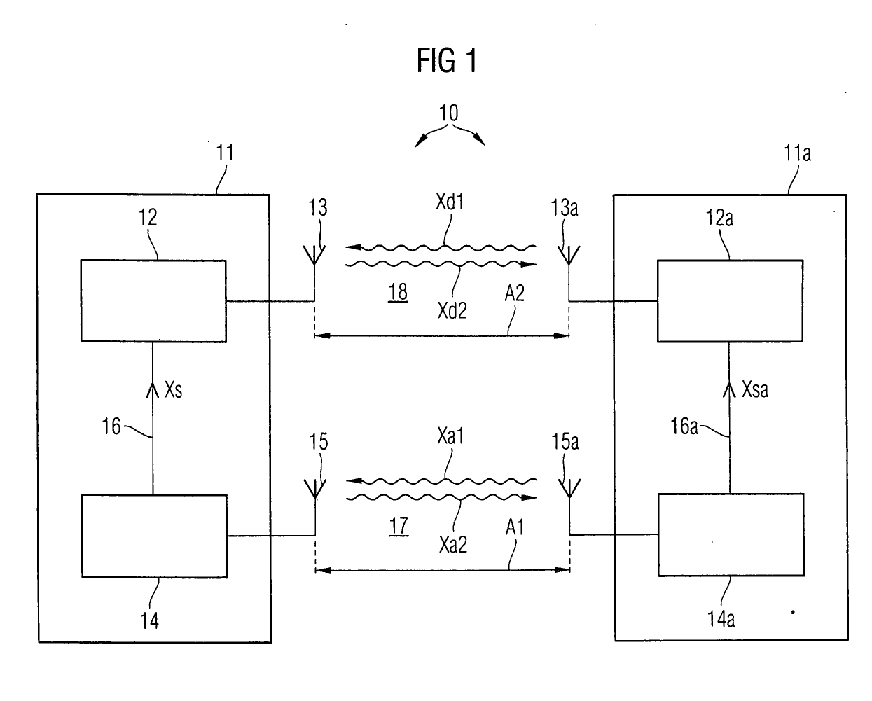

In one embodiment, as shown in FIG. 1, a Bluetooth-based communication system 10 has two Bluetooth subscribers 11, 11a. Alternatively, any suitable communication system may be used between subscribers 11, 11a. In this embodiment, for example, both subscribers 11, 11a have essentially identical communications circuitry and are authorized for a data communication within the communication system 10.

In one embodiment, the subscriber 11 functions as a master and the other subscriber 11a functions as a slave. Alternatively, for example, the subscriber 11 can function as both the master and slave. As illustrated in FIG. 1, the reference characters of all elements of the subscriber functioning as a slave have an “a” appended to them.

In one embodiment, the respective Bluetooth subscribers 11, 11a include a Bluetooth module 12, 12a, which is designed to carry out a data communication based on the Bluetooth standard with a corresponding other subscriber 11, 11a. The Bluetooth module 12, 12a has a transmitter/receiver antenna 13, 13a. The structure of a Bluetooth module 12, 12a is generally known in a plurality of different embodiments and variants, so that further details need not be covered below.

In one embodiment, a respective subscriber 11, 11a includes an acoustic module 14, 14a. The acoustic module 14, 14a is designed to set up and carry out a communication with a corresponding acoustic module 14, 14a of another subscriber 11, 11a. The acoustic module 14, 14a likewise contains a transmitter/receiver antenna 15, 15a. In one embodiment, the transmitter/receiver antenna is, for example, a loudspeaker and/or microphone of the communication subscriber 11, 11a. The acoustic module 14, 14a is connected to the respective Bluetooth module 12, 12a by way of a control line 16, 16a.

In one embodiment, the acoustic signals for agreeing to a key Xa1, Xa2 is generated and transmitted by the respective acoustic modules 14, 14a. The acoustic modules 14, 14a are designed to transmit signals, for example, according to the DTMF (Dual Tone Multi Frequency) method or to the known V.90 method. The V.90 method has been used for dialing up computers on a digital network with the aid of a modem, by way of analog connecting lines. In this embodiment, communication for agreeing to a key can be between mobile terminals and between a mobile terminal and a radio base station or between two radio base stations.

In one embodiment, for example, before the two subscribers 11, 11a can set up a data communication for the purpose of exchanging data, the subscriber 11a, functioning as a slave, first registers with the respective other subscriber 11 functioning as a master. This process is subsequently referred to as a registration mode or as pairing. During the registration mode, the two subscribers 11, 11a are brought together at a maximum distance A1. The maximum distance A1 is the maximum coverage for an acoustic communication. For example, if both subscribers 11, 11a are arranged at a distance from one another which is less than or equal to the maximum distance A1, then the subscriber 11a can register with the other subscriber 11.

In one embodiment, the acoustic module 14a of the subscriber 11a sends acoustic signals Xa1 to the respective acoustic module 14 of the other subscriber 11. The other subscriber 11 evaluates these acoustic signals Xa1. The other subscriber 11 transmits corresponding acoustic signals Xa2 to the acoustic module 14a of the subscriber 11a. The subscriber 11a evaluates the acoustic signals Xa2. In one embodiment, the subscribers 11, 11a are released for subsequent data communication if the authentication in both acoustic modules 14, 14a concerns authorized subscribers 11, 11a in each instance. The respective acoustic modules 14, 14a signal this to the Bluetooth module 12, 12a by way of respective control signals XS, XSa. For example, the Bluetooth module 12, 12a can now execute a data communication link with the respective Bluetooth module 12a of the subscriber which has just be authenticated, in which the data signals Xd1 and Xd2 are transmitted/received by way of the transmitter/receiver antenna 13, 13a.

In one embodiment, the transmission of data signals Xd1 and Xd2 is referred to as the normal mode and the two subscribers 11, 11a can be placed at a greater distance A2 from one another during the normal mode.

For example, the distance A2 defines the maximum coverage between the two subscribers 11, 11a, within which Bluetooth data communication can still be carried out reliably and successfully. Typically this maximum coverage A2 is significantly greater than the maximum coverage A1 for the acoustic-based agreement of a key.

In one embodiment, both the method for agreeing to a key over a communication path 17 and the data communication over a data communication path 18 can occur unidirectionally, for example, only from one subscriber 11, 11a to the opposite subscriber 11, 11a, or also bidirectionally, in other words from each subscriber 11, 11a to the other and back again. A multiplex method is also conceivable for both operational modes. In one alternative embodiment, for example, bidirectional communication can take place simultaneously.

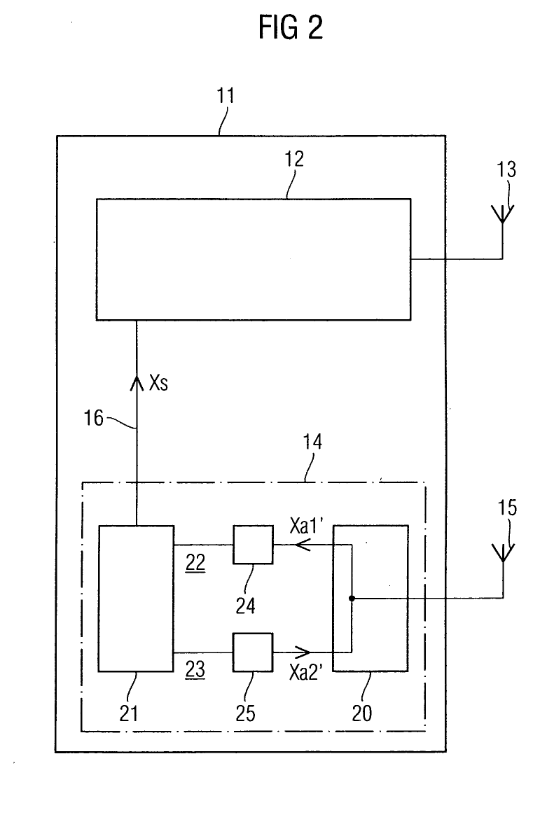

FIG. 2 shows a Bluetooth communication subscriber 11 as can be used in a communication system 10 from FIG. 1. In one embodiment, as shown in FIG. 2, the acoustic module 14 includes a transmitter/receiver device 20, as well as an evaluation device 21. The transmitter/receiver device 20 is connected to the transmitter/receiver antenna 15 and to the evaluation device 21. The transmitter/receiver device 20 can also be designed as a loudspeaker and/or microphone of a communication subscriber 11. In one embodiment, as shown in FIG. 2, a receive path 22 for a decoder 24, which serves to decode the received acoustic signals Xa1′, is connected between the evaluation device 21 and the decoder 24. An encoder 25 is provided in the transmitter path 23 for encoding the acoustic signals Xa2′ to be transmitted.

In one embodiment, the evaluation unit 21 generates a control signal Xs when a positive authentication is recognized and received acoustic signal Xa1 is assigned to an authorized subscriber.

The control signal Xs is forwarded to the Bluetooth module 12. The control signal Xs indicates to the Bluetooth module 12 that the actual data communication can be started with the authorized subscriber, which has just been authenticated.

In one alternative embodiment, the acoustic module 14 comprises only a transmitter/receiver device 20. This transmitter/receiver device 20 is designed to record acoustic signals Xa1 and to transmit corresponding acoustic signals Xa2 by way of the transmitter/receiver antenna 15. In this embodiment, the registration mode and the evaluation of the received acoustic signals Xa1′ are controlled here in the actual Bluetooth module 12.

In one embodiment, a program-controlled device is designed to control the actual data communication with other Bluetooth subscribers and to evaluate the acoustic signals Xa1, Xa2 exchanged during this data communication. The Bluetooth module 12 can comprise an encoder/decoder, which is arranged between the transmitter/receiver and the program-controlled device.

In one embodiment, the data signals Xs2 to be transmitted and/or the received data signals Xs1 are encoded and/or decoded respectively in the encoding/decoding device.

In another embodiment, the program-controlled device controls the communication for agreeing to a key and the registration mode. The transmitter/receiver device 20 is connected to the program-controlled device by way of a decoder. The program-controlled device is thus designed to additionally evaluate the received and decoded acoustic signals Xa1′. In this embodiment, the Bluetooth module 12 includes an encoder which is arranged downstream of the program-controlled device, and by which acoustic signals Xa2′ generated by the program-controlled device are encoded.

In one embodiment, a random number generator is provided to generate acoustic signals Xa2. For example, in this embodiment the random number generator is used instead of a program-controlled device and an encoder. The random number generator is operative to generate random signals Xa2′ on the output side controlled by way of the program-controlled device. The random signals Xa2′ are used to generate the acoustic signals Xa2 that are transmitted.

In one embodiment, the Bluetooth-based communication systems is provided in addition to a DECT system (Digital Enhanced Cordless Telecommunications). Alternatively, the Bluetooth-based communication systems is provided instead of a DECT system.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for agreeing to a key between communication subscribers of a wirelessly operating communication system, the method comprising:
using the key to determine at least one further communication key for security-related services, and
using acoustic signals for agreeing to the key being exchanged between the communication subscribers provided at a subsequent data transmission.

2. The method as claimed in claim 1, comprising:
using acoustic signals lying in a frequency band of about 0.4 KHz to 3.4 KHZ.

3. The method as claimed in claim 1, wherein the wirelessly operating communication system comprises a Bluetooth communication system or a Wireless Local Area Network communication system.

4. The method as claimed in claim 1, wherein the method comprises at least two operational modes; a first operational mode comprising exchanging acoustic signals for agreeing the key between the communication subscribers taking part in a data transmission, and a second operational mode comprising transmitting data after an implemented and successful agreement of the key.

5. The method as claimed in claim 4, wherein a maximum distance between the communication subscribers is smaller for the first operational mode than for the second operational mode.

6. The method as claimed in claim 1, comprising:
initializing the agreement of the key; and
wherein the further key comprises a subsequent communication link key.

7. The method as claimed in claim 1, comprising:
authenticating a communication subscriber following the agreement of the key during the authenticating operation.

8. The method as claimed in claim 7, wherein authenticating the communication subscriber is in accordance with the Bluetooth standard.

9. The method as claimed in claim 1, comprising:
exchanging an initialization key between the communication subscribers at the start of agreeing to the key.

10. The method as claimed in claim 9, comprising:
transmitting a password, PIN number, or both as the initialization key.

11. The method as claimed in claim 10, comprising:
generating the initialization key with a key agreement protocol.

12. The method as claimed in claim 9, comprising:
generating the initialization key with a random number generator.

13. The method as claimed in claim 1, comprising:
exchanging a shared secret between the communication subscribers during the agreement of the key.

14. A protocol for transmitting data, the protocol comprising:
using a communication key to determine at least one further communication key for security-related services, and
exchanging acoustic signals for agreeing to the communication key being exchanged between the communication subscribers provided at a subsequent data transmission.

15. A communication subscriber device used to agree a communication key between multiple communication subscribers, the communication subscriber device comprising:
a communication module for data transmission, the communications module operative to transmit and receive data signals,
a program-controlled device operative to control the data transmission and evaluate the received data signals,
an acoustic module for agreeing to a key, is the acoustic module operative to transmit and receive acoustic signal.

16. The communication subscriber as claimed in claim 15,
wherein the communication subscriber device comprises a Bluetooth communication subscriber for a Bluetooth communication system and the communication module being designed as a Bluetooth module for a data transmission according to the Bluetooth standard.

17. The communication subscriber as claimed in claim 15,
wherein the program-controlled device also is operative to control the agreement of a communication key, evaluate the acoustic signal, or both.

18. The method as claimed in claim 9, comprising:
agreeing at least one further communication key based upon the initialization communication key.

19. The method as claimed in claim 10, comprising:
generating the initialization key with a Diffie-Hellmann protocol.
